(19) United States
(12) Patent Application Publication
(10) Pub. No.: US 2010/0192102 A1
(43) Pub. Date: Jul. 29, 2010

(54) DISPLAYING RADIAL MENUS NEAR EDGES OF A DISPLAY AREA

(75) Inventors: Paul R. Chmielewski, Byron, MN (US); Brian J. Cragun, Rochester, MN (US); Michael J. Fork, Gibsonburg, OH (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 12/362,033

(22) Filed: Jan. 29, 2009

(51) Int. Cl. G06F 3/048

(52) U.S. Cl. 715/834

(57) ABSTRACT

Embodiments of the invention provide radial menus that allow users to quickly make selections of menu items using simple gestures. A radial menu may be displayed on a display screen in response to detecting a predefined screen pointer event such as a mouse click. Thereafter simple strokes using the screen pointer may be employed to select a desired item. The radial menus may be displayed on the display screen such that all radial menu items are visible thereon and there is sufficient space for making gestures for selecting radial menu items.

### BACKGROUND OF THE INVENTION

1. Field of the Invention

The present invention is generally related to graphical user interfaces (GUIs), and more specifically to displaying radial menu items near edges of a display area.

2. Description of the Related Art

Most modern computers include applications that allow a user to interact with the application while performing operations associated with the applications. For example, an application may be configured to receive commands from the user to display data, modify data, initiate a particular task, and the like. In the past, user interaction with applications was facilitated by a command line interface. The command line interface allowed users to type predefined commands to interact with an application. However, command line interfaces require users to memorize large lists of commands to communicate with each application.

More recently, user interaction with applications has involved the use of graphical user interfaces, or GUIs. For example, most applications today are configured to display a window including a menu bar on a display screen. The menu bar may include one or more pull down menus including lists of functions and commands that may be used to interact with the application.

### SUMMARY OF THE INVENTION

The present invention is generally related to graphical user interfaces (GUIs), and more specifically to displaying radial menu items near edges of a display area.

One embodiment of the invention provides a method for displaying a radial menu in a display area. The method generally comprises receiving a predefined screen pointer event, and in response to receiving the predefined screen pointer event, determining a first distance from a screen pointer to at least one edge of the display area. The method further comprises determining whether the first distance is smaller than a radius of the radial menu, and upon determining that the first distance is smaller than the radius of the radial menu, displaying the radial menu in the display area such that a center of the radial menu is at least a second distance from the edge, the second distance being at least as long as the radius of the radial menu.

Another embodiment of the invention provides a computer readable storage medium comprising a program product which, when executed by a processor, is configured to perform an operation for displaying a radial menu in a display area. The operation generally comprises receiving a predefined screen pointer event, and in response to receiving the predefined screen pointer event, determining a first distance from a screen pointer to at least one edge of the display area. The operation further comprises determining whether the first distance is smaller than a radius of the radial menu, and upon determining that the first distance is smaller than the radius of the radial menu, displaying the radial menu in the display area such that a center of the radial menu is at least a second distance from the edge, the second distance being at least as long as the radius of the radial menu.

Yet another embodiment of the invention provides a system, generally comprising a memory comprising a program, and a processor. The processor, when executing the program, is generally configured to receive a predefined screen pointer event, and in response to receiving the predefined screen pointer event, determine a first distance from a screen pointer to at least one edge of a display area. The processor is further configured to determine whether the first distance is smaller than a radius of the radial menu, and upon determining that the first distance is smaller than the radius of the radial menu, display the radial menu in the display area such that a center of the radial menu is at least a second distance from the edge, the second distance being at least as long as the radius of the radial menu.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a drop-down menu according to the prior art.

FIG. 2 illustrates an exemplary system according to an embodiment of the invention.

FIG. 3 illustrates an exemplary radial menu according to an embodiment of the invention.

FIGS. 4A-4C illustrate further exemplary radial menus according to embodiments of the invention.

FIG. 5 illustrates an exemplary screen pointer event for displaying a radial menu, according to an embodiment of the invention.

FIG. 6 illustrates an exemplary stroke according to an embodiment of the invention.

FIGS. 7A-7C illustrate exemplary strokes for selecting a radial menu item, according to an embodiment of the invention.

FIG. 7D illustrates an overloaded radial menu according to an embodiment of the invention.

FIG. 7E illustrates an exemplary graphical user interface for defining gestures, according to an embodiment of the invention.

FIG. 8 illustrates an exemplary selection zone according to an embodiment of the invention.

FIG. 9 illustrates another exemplary selection zone according to an embodiment of the invention.

FIGS. 10A-B illustrate a screen pointer event near an edge of a display area, according to an embodiment of the invention.

FIGS. 11A-B illustrate displacement of a radial menu according to an embodiment of the invention.

FIG. 12 illustrates activation of a radial menu item according to an embodiment of the invention.

FIG. 13 illustrates activation of a radial menu item according to another embodiment of the invention.

FIG. 14 illustrates movement of a screen pointer according to an embodiment of the invention.

FIG. 15 is a flow diagram of exemplary operations performed by a menu manager according to an embodiment of the invention.

FIG. 16 illustrates a radial menu initialization zone according to an embodiment of the invention.

FIG. 17 is a flow diagram of exemplary operations performed by a menu manager according to another embodiment of the invention.

### DETAILED DESCRIPTION OF THE PREFERRED EMBODIMENTS

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

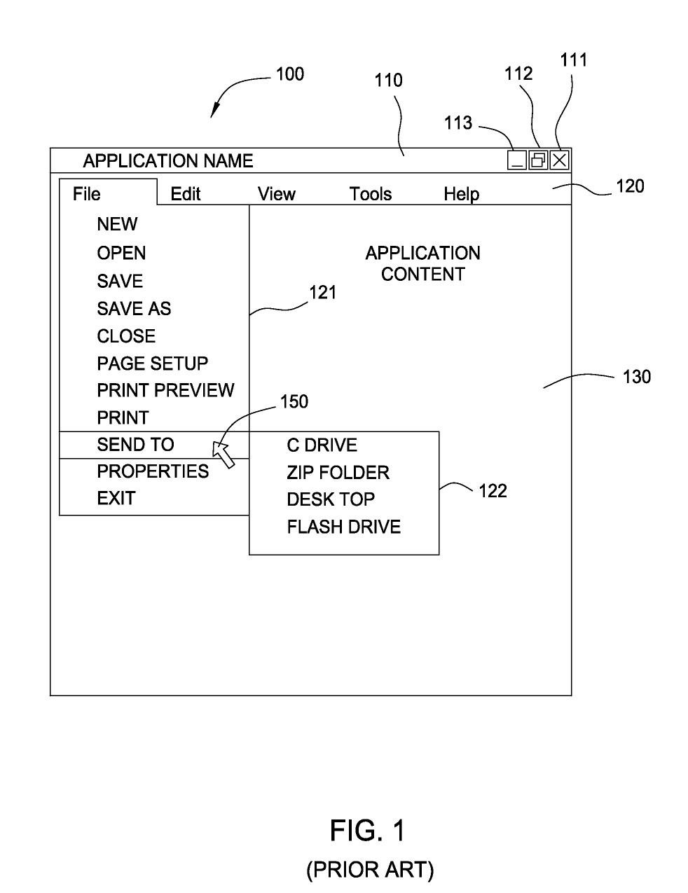

FIG. 1 illustrates an exemplary graphical user interface (GUI) 100 according to the prior art. GUI 100 may be displayed on a display screen, such as, for example, a computer monitor to facilitate communication between a user and an application. As illustrated in FIG. 1, GUI 100 includes a title bar 110, a menu bar 120, and an application content area 130. The application content area 130 includes graphical representations of application content including text, images, video, spreadsheets, and the like.

The title bar 110 displays the application name and one or more buttons, including a close button 111, a maximize/restore button 112, and a minimize/restore 113. The close button, when clicked, may be configured to close the application, the maximize/restore button 112 may be configured to toggle the size of the GUI 100 between two predefined sizes (for example, a sized window and a maximized window), and the minimize/restore button 113 may be configured to reduce the GUI 100 into, for example, a task bar.

The menu bar 120 includes a plurality of menus including the File menu, Edit menu, View menu, Tools menu, and Help menu, as illustrated in FIG. 1. A particular menu may be selected from the menu bar, for example, by clicking on a desired menu using a mouse. Each of the menus in the menu bar 120 are drop down menus. Therefore, when a particular menu is selected, a list of items in the menu is displayed. FIG. 1, illustrates an exemplary list of items 121 displayed when the File menu is selected.

A particular item may be selected from a drop down menu by moving the mouse pointer vertically up and down the list until the mouse pointer is above a desired item. In some cases a visual indication of the particular item under the mouse pointer may be provided. For example, as illustrated in FIG. 1, a mouse pointer 150 is over the Send To item of the File menu. Therefore, the Send To item is shaded with a different colored background to indicate that the mouse pointer is over the Send To item.

Selecting a menu item may include performing a second mouse click to select the desired item. For example, a first mouse click on a desired menu may display menu items in a drop down list. A user may then move a mouse pointer vertically up and/or down until the mouse pointer is over a desired menu item. A visual indication, for example, shading may indicate the item over which the mouse pointer lies to aid the user in making the selection. Once the mouse pointer is above the desired menu item, a second click of the mouse may result in the selection of the menu item.

In some cases, a menu item may be a sub-menu. For example, the Send To item of the File Menu may be a sub-menu. Accordingly, as illustrated in FIG. 1, moving the mouse pointer over the Send To item may result is a cascaded sub-menu 122 to be displayed. Each cascaded sub-menu may have its own cascaded sub menu, which may result in several cascaded sub-menus being displayed before the desired item is selected.

The GUI 100 provides several advantages over traditional command line interfaces. For example, a user of the GUI 100 need not memorize commands associated with a large number of menu items because he/she may simply explore and navigate the menu items via the menu bar to communicate with the application. However, menu bars and drop down menus are not efficient at allowing a user to quickly select a desired item. First, selecting a menu item requires at least two mouse clicks as described above. Second, in drop down menus having a large number of items, the menu items may be closely spaced, which may require the user to scan up and down along the menu several times before a desired item is found. Furthermore, drop down menus with a large number of closely spaced items have an increased probability of erroneous selection of menu items.

The inefficiency of drop down menus may adversely affect users of applications where a fast response time is desired from the user while interacting with the applications. For example, in a gaming application a user's response time in responding to a particular circumstance in the game may be critical to the user's performance in the game. As an example, in a game where performance is determined by the user's ability to defeat opponents in a fight, the ability of the user to detect and quickly attack opponents may be crucial to performing successfully completing the game.

Embodiments of the invention provide radial menus that allow users to quickly make selections of menu items using simple gestures. A radial menu may be displayed on a display screen in response to detecting a predefined screen pointer event such as a mouse click. Other screen pointer events may include touching the display screen with a finger or stylus pen, pressing one or more keys on a keyboard, receiving a voice command, and the like. Thereafter, a first stroke may be made with the screen pointer to activate a desired radial menu item. A predefined second stroke may be made to select the active radial menu item.

### Exemplary System

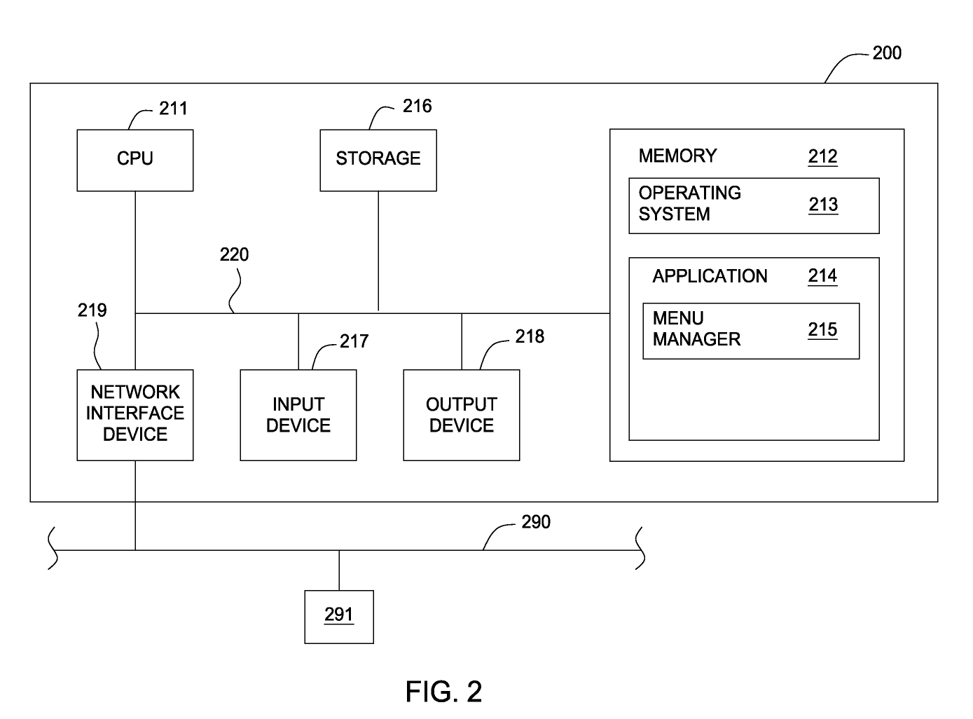

FIG. 2 depicts a block diagram of a system 200 in which embodiments of the invention may be implemented. The system 200 may include a Central Processing Unit (CPU) 211 connected via a bus 220 to a memory 212, storage 216, an input device 217, an output device 218, and a network interface device 219. The input device 217 can be any device to give input to the system 200. For example, a keyboard, keypad, light-pen, touch-screen, track-ball, or speech recognition unit, audio/video player, and the like could be used. The output device 218 can be any device to give output to the user, e.g., any conventional display screen. Although shown separately from the input device 217, the output device 218 and input device 217 could be combined. For example, a display screen with an integrated touch-screen, a display with an integrated keyboard, or a speech recognition unit combined with a text speech converter could be used.

The network interface device 219 may be any entry/exit device configured to allow network communications between the system 200 and one or more other devices 291 via a network 290. For example, the network interface device 119 may be a network adapter or other network interface card (NIC).

Storage 216 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 212 and storage 216 could be part of one virtual address space spanning multiple primary and secondary storage devices.

The memory 212 is preferably a random access memory sufficiently large to hold the necessary programming and data structures of the invention. While memory 212 is shown as a single entity, it should be understood that memory 212 may in fact comprise a plurality of modules, and that memory 212 may exist at multiple levels, from high speed registers and caches to lower speed but larger DRAM chips.

Illustratively, the memory 212 contains an operating system 213. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 212 may also include one or more applications 214. The applications 214 may be software products comprising a plurality of instructions that are resident at various times in memory and storage devices in the computer system 200. When read and executed by one or more CPU 211, the applications 214 may cause the computer system 200 to perform the steps necessary to execute steps or elements embodying the various aspects of the invention.

In one embodiment, the applications 214 may include a menu manager program 215, which may be configured to display a radial menu on the output device 218, and detect selection of one or more radial menu items, as is discussed in greater detail below. In some embodiments the application program 214 and menu manager 215 may reside on a networked computer device 291 and may be configured to manage radial menus on the output device 118 of computer system 200. The applications 214 may also include user preferences 221. The user preferences 221 may determine one or more characteristics of radial menus, for example, the displaying of radial menus, making selections from radial menus, and the like, as will be discussed in greater detail below.

### Exemplary Radial Menus

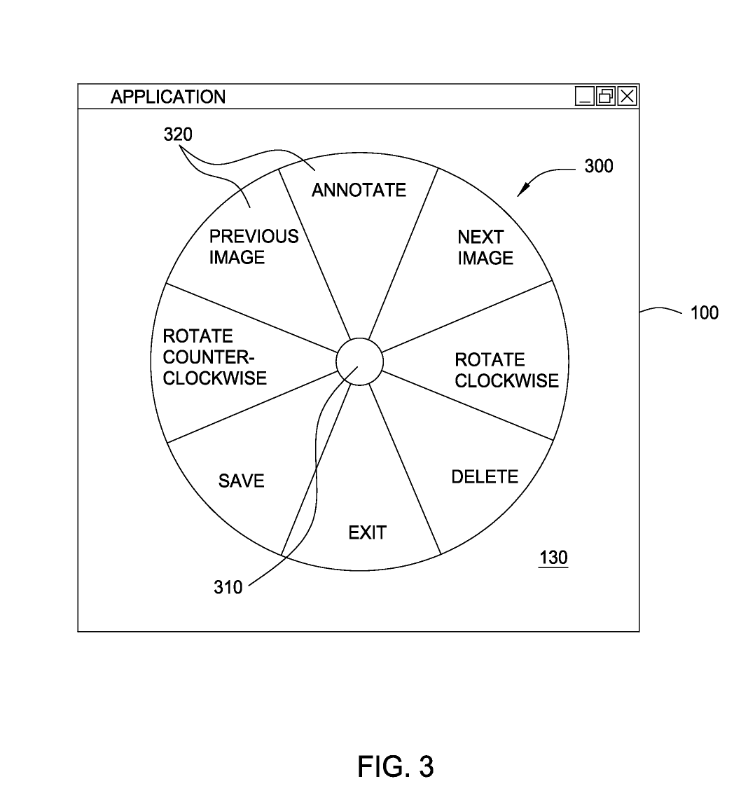

FIG. 3 illustrates an exemplary radial menu 300, according to an embodiment of the invention. In one embodiment, the radial menu 300 may be displayed in an application window 100 by the menu manager 115, as illustrated in FIG. 3. However, in alternative embodiments, the menu manager 115 may be configured to display the radial menu 300 at any location on a screen, whether inside or outside a window.

In general, the radial menu 300 may include a center 310 and a plurality of radial menu items 320 placed radially outwards from the center 310. For purposes of illustration, the radial menu 300 is assumed to be associated with an image editing software. Accordingly, the radial menu items 320 displayed in FIG. 3 include “Previous Image”, “Next Image”, “Annotate”, “Rotate Clockwise”, “Rotate Counterclockwise”, “Save”, “Exit”, and “Delete”. In a particular embodiment, the radial menu 300 may include between 6 and 8 radial menu items, however, any reasonable number of radial menu items may be included in the radial menu 300 in other embodiments.

The radial menu items 320 may be selected by using a screen pointer such as, for example, a mouse pointer, a stylus pen, trackball pointer, a remote wireless controller, and the like, as is described in greater detail below. Each of the radial menu items 320 may be associated with commands and/or functions that may be used to communicate with an application 114 associated with the radial menu 300. For example, the “Next Image” radial menu item, when selected, may cause a new image to be displayed in an application content area 130 of window 100 in FIG. 3. As another example, the “Annotate” radial menu item, when selected, may launch a function that may allow a user to insert annotations for an image displayed in the application content area 130. In some embodiments, selecting a radial menu item may result in a second or cascaded radial menu to be displayed.

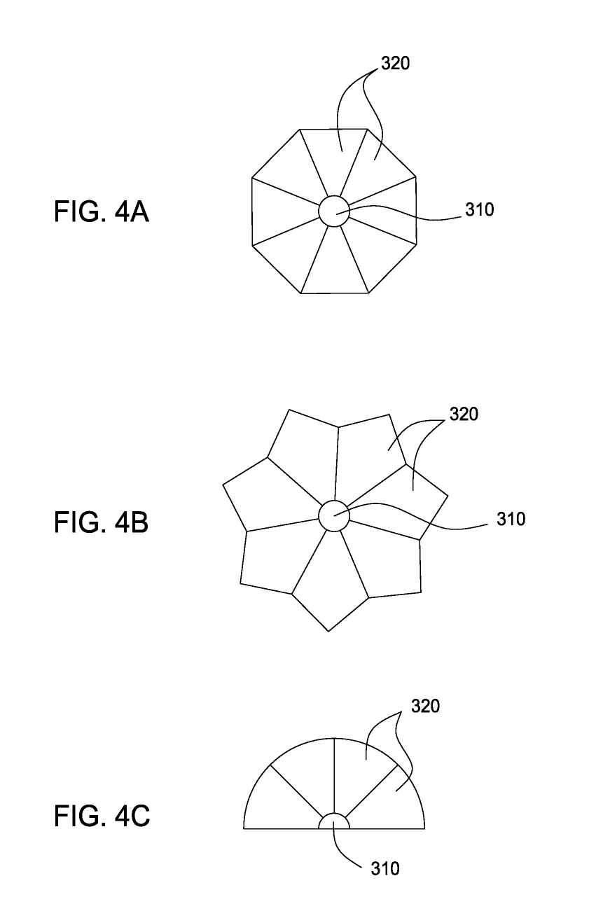

In one embodiment of the invention, the radial menu items 320 may be displayed as a “pie slices” 320, as illustrated in FIG. 3. However, in alternative embodiments, the radial menu items may have any reasonable shape that allows a plurality of radial menu items 320 to be displayed radially outwards from the center 310. FIGS. 4A and 4B, illustrate some alternative shapes for the radial menu items 320. Furthermore, while a circular radial menu 300 is illustrated in FIG. 3, in alternative embodiments, the radial menu 300 may be semicircular, quadra circular, or any other radial shape. For example, FIG. 4C illustrates a semicircular radial menu, according to an embodiment of the invention.

The radial menu 300 may be a pop-up menu that is displayed upon the occurrence of a predefined screen pointer event. For example, in one embodiment, the menu manager 115 may be configured to display the radial menu 300 on a screen (for example, in window 100) upon detecting a mouse click. In a particular embodiment, the radial menu 300 may be displayed when a right button of a mouse is clicked. While using mouse clicks to display radial menus is described herein, alternative screen pointer events that may cause a radial menu to appear may include, for example, touching a screen with a stylus pen or finger, pressing one or more keys on a keyboard, receiving a voice command, and the like.

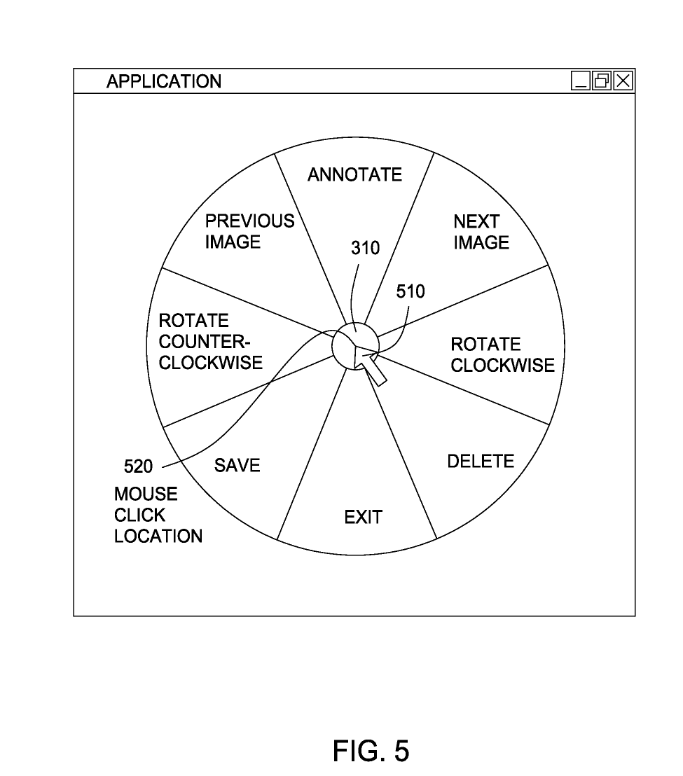

In one embodiment of the invention, the menu manager 115 may display the radial menu such that the center of the radial menu aligns with the screen pointer. FIG. 5 illustrates a radial menu 300 displayed such that the center 310 of the radial menu 300 aligns with a location 520 of a screen pointer 510. As illustrated in FIG. 5, the screen pointer may be a mouse pointer and the location 520 may be a location of the mouse pointer when the mouse is clicked. Alternatively the location 520 may be the location where a stylus pen or finger touches a display screen.

Selection of a radial menu item from a radial menu may involve moving the screen pointer 510 in the direction of a desired radial menu item 320. For example, to select the “Annotate” radial menu item, the screen pointer may be moved straight up (in a generally 90 degrees direction) towards the pie slice of the “Annotate” radial menu item. The moving of the screen pointer on the display screen is generally referred to hereinafter as a “stroke”. In the case of a mouse pointer, strokes may be performed by simply moving the mouse on a mouse pad. While using a stylus pen or finger on a touch screen, the finger or stylus pen may simply be dragged across the screen to perform a stroke.

Placing the screen pointer over a radial menu item 320 may cause the radial menu item to become active. When a radial menu item 320 is active, the occurrence of a selection event, such as, for example, a mouse click, may cause the radial menu item 320 to be selected. In one embodiment of the invention, the menu manager 115 may be configured to provide a visual indication to identify an active radial menu item.

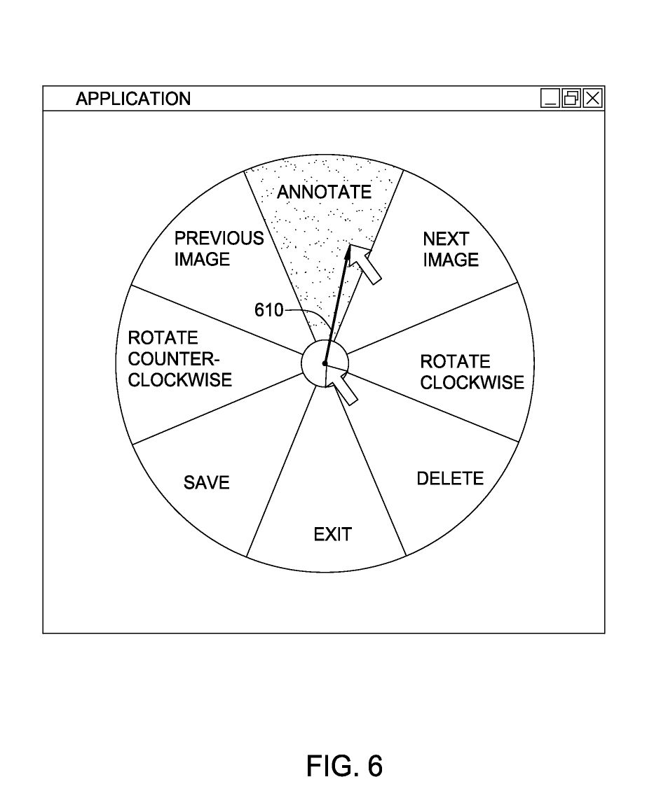

FIG. 6 illustrates an exemplary stroke 610 which results in the activation of a radial menu item, according to an embodiment of the invention. As illustrated in FIG. 6, the stroke 610 moves the screen pointer over the “Annotate” radial menu item. As a result, the menu manager 115 may change the background color of the “Annotate” pie slice, which is indicated by the shading of the “Annotate” pie slice in FIG. 6. The change in color may identify the “Annotate” radial menu item as the active item. Other methods for providing a visual indication such as, for example, bold facing the letters of the active radial menu item, dimming or fading the pie slices or letters of non-active radial menu items, and the like, are also contemplated. While a straight line stroke is illustrated in FIG. 6, the stroke 610 may include any movement in any and/or multiple directions on a display screen in alternative embodiments.

In one embodiment, the center 310 of the radial menu 300 may be an inactive center. In other words, no radial menu items 320 may be active while the screen pointer 510 lies over the center portion 310. Therefore, when the menu manager 115 aligns the center 310 of the radial menu when the radial menu is displayed as described above, no radial menu items 320 may be initially active. Thereafter, user strokes may cause one or more radial menu items to become active. If the user strokes return the screen pointer to the center 310, all radial menu items may again become inactive.

One embodiment of the invention may allow radial menu items 320 to be selected in a single gesture. In general, a gesture may include at least one or more strokes. Additionally, in some embodiments, a gesture may include one or more screen pointer events such as, for example, mouse click downs (pressing a mouse button), mouse click offs (releasing the mouse button), touching a screen with a stylus pen or finger, removing stylus pen or finger from the screen and the like. The menu manager 115 may be configured to analyze gestures performed on a display screen to determine whether a radial menu item is selected. In one embodiment, a plurality of predefined gestures may correspond to respective menu item selections.

For example, an exemplary gesture for selecting a radial menu item may include performing a first mouse click, i.e., a mouse button click down and release. The first mouse click may display a radial menu, for example, the radial menu 300 on the display screen. Thereafter, one or more strokes may be performed to move the mouse pointer over a desired radial menu item 320. As discussed above, menu manager 115 may provide a visual indication that the desired radial menu item is active. When the mouse pointer is over the desired radial menu item, the mouse may be clicked a second time. Because the second mouse click occurred while the mouse pointer is above a radial menu item 320, the menu manager may determine that a radial menu item selection has occurred. Therefore, the menu manager 115 may cause a command or function associated with the selected radial menu item to be executed. In this example, the combined events of the first mouse click, the subsequent one or more strokes, and the second mouse click define the exemplary gesture.

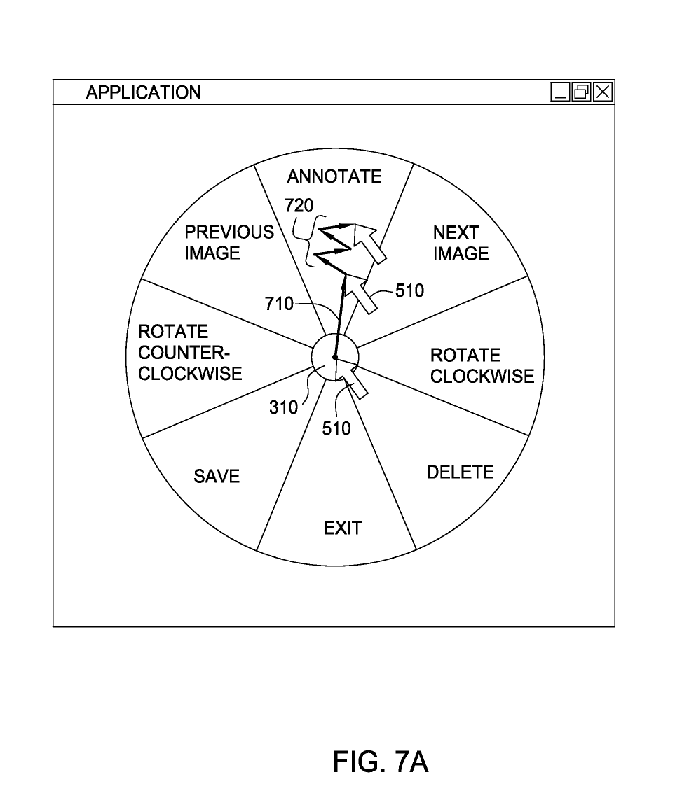

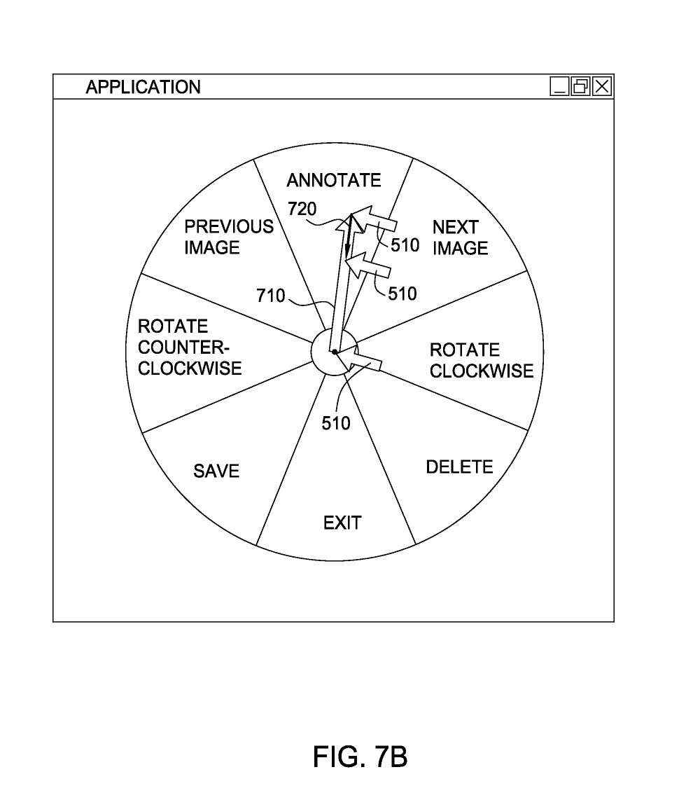

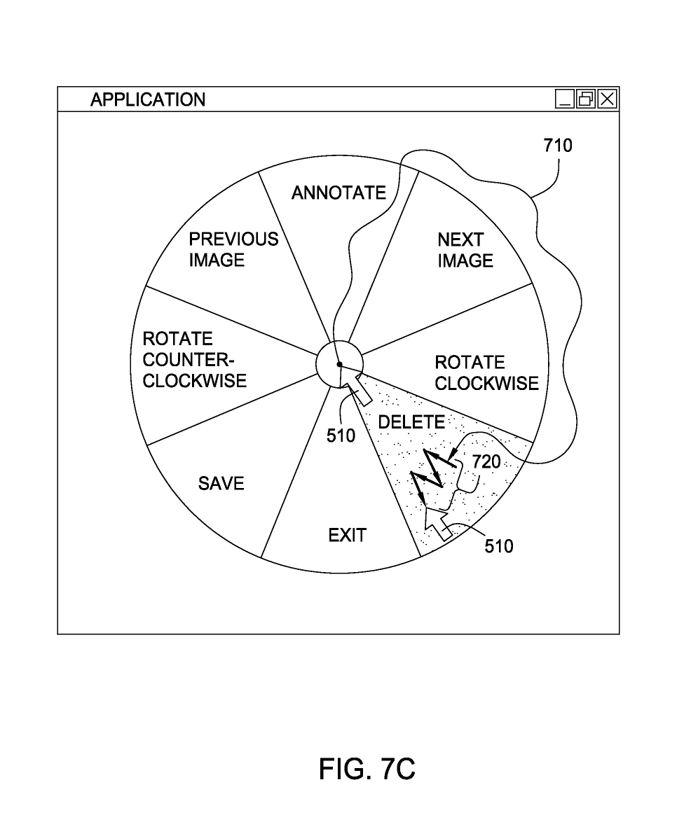

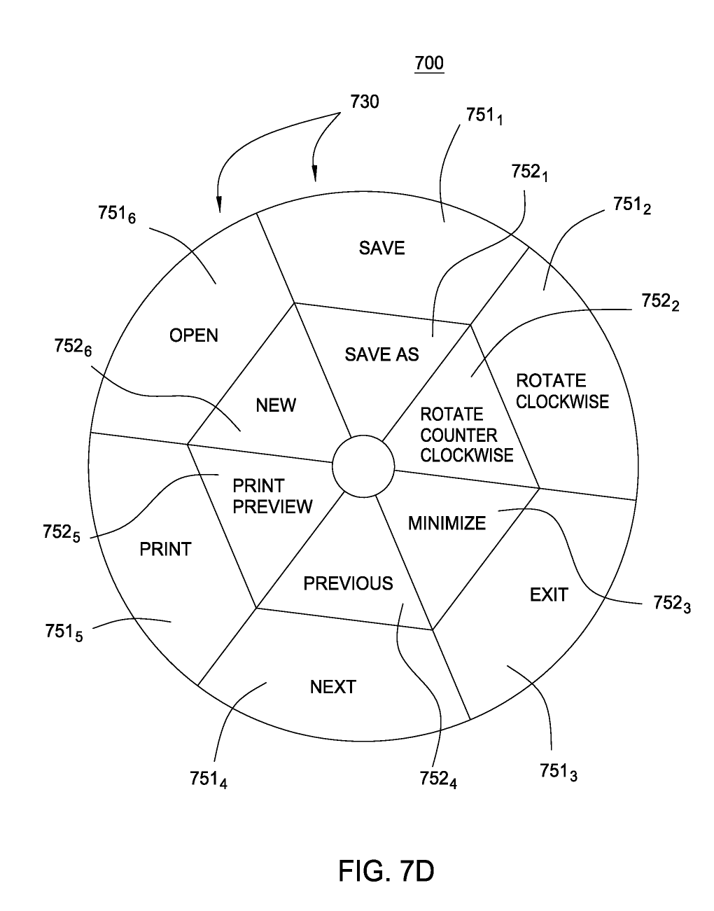

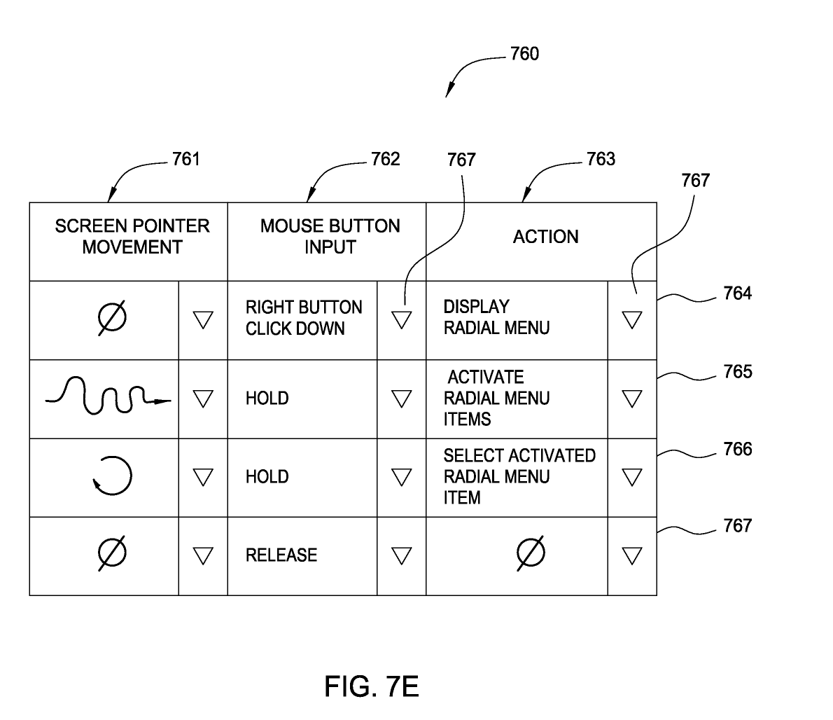

In one embodiment of the invention, a gesture for selecting a radial menu item may include a first mouse click (i.e., a mouse click down and release) that causes a radial menu to be displayed on the display screen, a first stroke configured to activate a radial menu item, and a predefined second stroke that is configured to select the radial menu item. FIG. 7A illustrates exemplary first and second strokes according to an embodiment of the invention. As illustrated in FIG. 7A, a first stroke 710 may move the screen pointer 510 from a center 310 of the radial menu to the “Annotate” radial menu item. Thereafter, a predefined second stroke may be performed to select the “Annotate” radial menu item. As illustrated in FIG. 7A, predefined second stroke may involve moving the screen pointer in a zigzag back and forth motion over a same path. If the predefined back and forth motion is detected by the menu manager while the screen pointer is over a radial menu item, the radial menu item may be selected.

Any reasonable predefined movement of the screen pointer 510 may be used as a radial menu selection event. FIG. 7B illustrates an alternative predefined second motion that may result in the selection of a radial menu item. As illustrated in FIG. 7B, a first stroke may move the screen pointer 510 from a center 310 of the radial menu to the “Annotate” radial menu item. A predefined second stroke may move the screen pointer back in a direction towards the center 310, which may result in the selection of the “Annotate” radial menu item. Still another alternative predefined second strokes may include substantially circular and/or semi-circular movement of the screen pointer over the radial menu item.

In another embodiment, the gesture for selecting a radial menu item may involve a mouse button click down (without release), a first stroke for activating a radial menu item, and a second predefined stroke for selecting the radial menu item. The mouse button may be released after selection of the radial menu item. The mouse button click down may cause a radial menu to be displayed. The first stroke and predefined second stroke may function as described above.

In some embodiments, if a second predefined stroke is not received within a predefined period of time after activation of the radial menu, the menu manager 115 may be configured to close the radial menu. Closing the radial menu may involve removing the radial menu from the display screen. In some embodiments, the predefined period of time may begin after completion of the first stroke. For example, a screen pointer event may cause the radial menu to be displayed. Thereafter, a first stroke may be completed to activate a radial menu item. If the predefined second stroke is not received within the predefined period of time after completion of the first stroke, the radial menu may be closed by the menu manager 115.

In yet another embodiment, the menu manager 115 may select an active radial menu item if the radial menu item has been active for a predefined period of time. Accordingly, the gesture for selecting a radial menu item may involve a mouse button click down (with or without release), and a first gesture for activating a radial menu item. The mouse button click down may cause a radial menu to be displayed. The first stroke may function as described above to activate a radial menu item. The menu manager 115 may monitor the time for which a particular radial menu item has been active, and select the radial menu item after the predefined period of time.

While the first stroke is illustrated as a straight line from the center 310 of the radial menu to a desired radial menu element 320, in some embodiments, the first stroke may include movement along any part of the display screen. For example, a user may initially move the screen pointer in the direction of a first radial menu item, but then decide to choose a second radial menu item instead. Accordingly, the user may move the screen pointer across the screen until the desired second radial menu item is activated. Once the second radial menu item is activated, the user may perform the predefined second stroke to select the second radial menu item.

FIG. 7C illustrates exemplary first and second strokes according to another embodiment of the invention. As illustrated in FIG. 7C, the first stroke 710 may include an initial movement towards a first radial menu item (“Annotate”). The first stroke 710 may continue to move across the screen until a second radial menu item (“Delete”) is activated, as indicated by the shading. Thereafter, a predefined second stroke 720 may be performed to select the second radial menu item. In some embodiments, the first stroke may include movement over multiple radial menu items until a desired radial menu item is activated.

In one embodiment of the invention, a gesture for selecting a radial menu item may include a first mouse click (i.e., a mouse click down and release) that causes a radial menu to be displayed on the display screen, and a first stroke configured to activate and select the radial menu item. The first stroke may activate a menu item 320 when the mouse pointer is moved thereon. Furthermore, the menu manager 115 may be configured to analyze a speed of the screen pointer during the first stroke. If the speed exceeds (or falls below) a predefined threshold value, the activated radial menu item may be selected. The threshold speed values may be user configurable in some embodiments. For example, the threshold speed values may be defined by a user in the user preferences 221 (See FIG. 2).

In one embodiment of the invention, each pie slice of the radial menu may be overloaded with two or more radial menu items. FIG. 7D illustrates an exemplary radial menu 700 comprising a plurality of pie slices 730. As illustrated in FIG. 7D, each pie slice 730 may include a first radial menu item 751 and a second radial menu item 752. In one embodiment of the invention, a gesture for selecting a first radial menu item 751 may include a first mouse click (i.e., a mouse click down with or without release) that causes a radial menu to be displayed on the display screen, a first stroke configured to activate the first radial menu item 751, and a corresponding second radial menu item 752, and a predefined second stroke configured to select the first radial menu item 751. An exemplary predefined second stroke may include a stroke in a clockwise direction. A gesture for selecting a second radial menu item 751 may include a first mouse click (i.e., a mouse click down with or without release) that causes a radial menu to be displayed on the display screen, a first stroke configured to activate the second radial menu item 752 and a corresponding first radial menu item 751, and a predefined third stroke configured to select the second radial menu item 751. An exemplary predefined third stroke may include a stroke in the counter-clockwise direction.

In one embodiment of the invention, a user may be allowed to define the particular gesture for selecting items from a radial menu. For example, in one embodiment, the application 114 may be configured to display a graphical user interface that allows a user to define a gesture for selecting radial menu items. The user defined gesture may be stored in the user preferences 221, in one embodiment. FIG. 7E illustrates an exemplary graphical user interface for defining a gesture for selecting radial menu items. As illustrated in FIG. 7E, the user preferences 221 may include a first column for defining screen pointer movement (or strokes), a second column 762 for defining mouse button input, and a third column 763 for defining an action performed based on the defined inputs in columns 761 and 762.

As illustrated in FIG. 7E, the GUI 760 may include a plurality of drop down menus 767 for defining the particular inputs and the actions performed in response to the inputs. Alternatively, the GUI may include radio buttons, text boxes, check boxes, and the like for defining the inputs and actions. In some embodiments, the GUI 760 may include a screen where the input (for example, strokes and mouse clicks) may be performed to define the inputs and/or actions.

The first row 764 defines an exemplary screen pointer event, i.e, right mouse button click down, that results in a radial menu being displayed. Alternatively, a right mouse button click down and click off may also be selected as a predefined screen pointer event for displaying a radial menu. As can be seen in row 764 of FIG. 7E, the no screen pointer movement has been defined. In alternative embodiments, the user may define a screen pointer movement for displaying the radial menu instead of (or in addition to) the right button mouse click down.

Row 765 illustrates inputs for activating radial menu items. As illustrated, if radial menu items may be activated when the right mouse button is held down and the screen pointer is moved in any direction as illustrated by the symbol in row 765, column 761. Alternatively, a user may choose to select a straight line movement of the screen pointer for selecting radial menu items. Row 766 illustrates a predefined second stroke, i.e., a circular stroke, for selecting a radial menu item. Row 767 illustrates a mouse button click off. While no action is shown for the mouse button click off on FIG. 7E, in some embodiments, the mouse button click off may result in predefined action, for example, selection of the radial menu item, removing of the radial menu from the display screen, or the like.

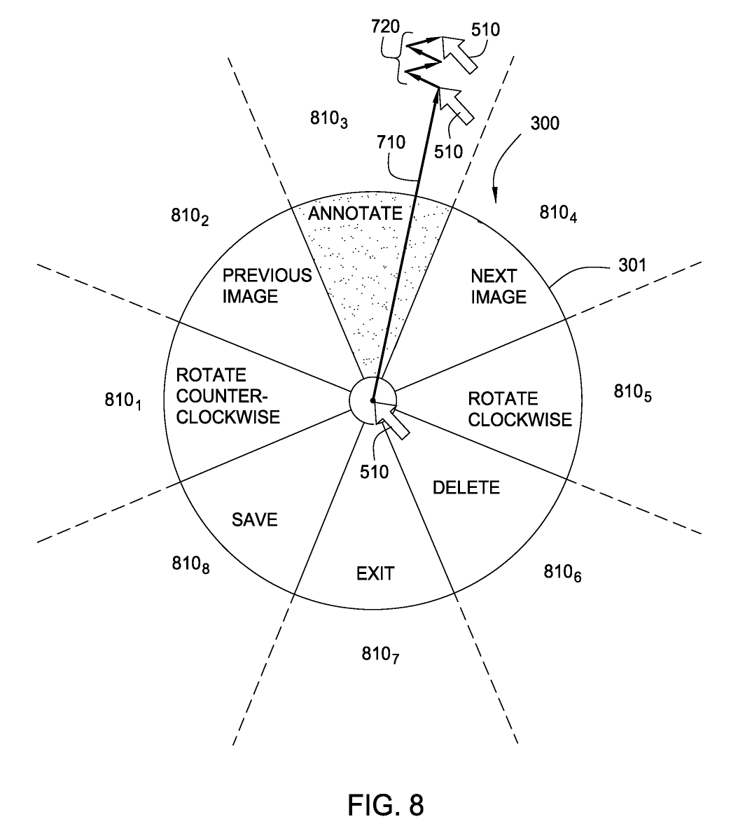

In one embodiment of the invention, it may be possible to select radial menu items even though a selection event occurs outside the bounds of the radial menu. FIG. 8 illustrates an exemplary radial menu 300 comprising a plurality of extra-territorial zones 810₁₋₈ associated with respective radial menu items 320. As shown in FIG. 8, the zones 810₁₋₈ may be outside the visible bounds of the radial menu 300. As shown in FIG. 8, the outside bounds of the radial menu 300 are demarcated by a circle 301. The circle 301 is merely illustrative. In other embodiments, any visible geometric shape 301 is contemplated. In one embodiment of the invention, if a screen pointer is in a zone 810, the radial menu item 320 associated with the zone 810 may be active. Accordingly, if a selection event occurs in the zone 810, a selection of the radial menu item associated with the zone 810 may occur. In other words, a pie slice of the radial menu item 320 and a respective zone 810 may define a selection zone of a radial menu item within which gestures may be performed for selection of the radial menu item.

For example, FIG. 8 illustrates a first stroke 810 which moves the screen pointer 510 across the “Annotate” radial menu item pie slice and into the zone 810₃ associated with the “Annotate” radial menu item. As can be seen in FIG. 8, the “Annotate” radial menu item remains active even though the screen pointer is outside the bounds of the radial menu 300. Further as depicted in FIG. 8, a predefined second stroke 720 may occur in the zone 810₃ associated with the “Annotate” radial menu item. The menu manager 115 may detect the predefined second stroke in the zone 810₃ and cause the respective “Annotate” radial menu item to be selected.

Allowing users to make elongated first strokes such as, for example, the elongated first stroke 710 in FIG. 8 may reduce errors in selection of radial menu items. As can be seen in FIG. 8, the further the screen pointer is moved from the center 310 of the radial menu, the greater the area that is available for making gestures such as, for example, the predefined second gestures. By providing greater area for gestures, the probability of gesture strokes accidentally moving into zones 810 of undesired radial menu items may be reduced.

Furthermore, activating radial menu items as a user performs a first stroke that is outside the bounds of the radial menu item may allow greater precision in the activation of a desired radial menu item. For example, the further the screen pointer 510 is from the center 310, the greater the radial distance that must be travelled by the screen pointer 510 to a zone 810 of an adjacent radial menu item. One skilled in the art will appreciate that allowing a user to move the screen pointer in a wider arcs around the radial menu allows increased precision in activating desired radial menu items.

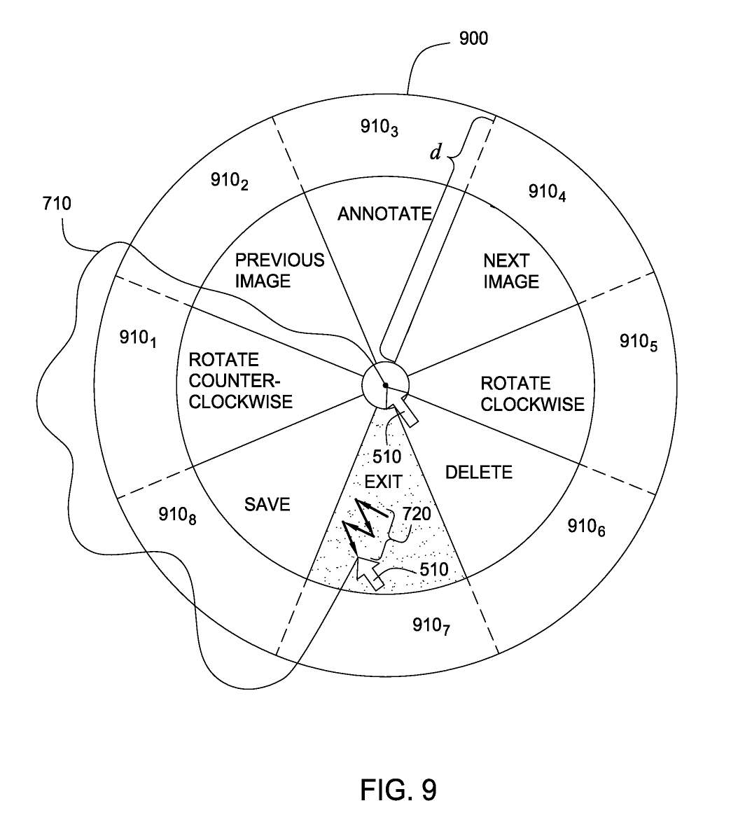

As illustrated in FIG. 8, in some embodiments the zones 810 may extend to the edges of a display area, for example, to the edges of a display screen, an application window, or the like. In an alternative embodiment, a predefined limited selection zone may be defined outside the bounds of the radial menu for receiving selections of radial menu items. FIG. 9 illustrates a circular perimeter 900 around the radial menu 300 that defines a plurality of zones 910₁₋₈ for each of the radial menu items 320. In one embodiment, the perimeter may be made visible to the user, for example, by displaying a solid line, dashed line, shading the zones 910, or the like. The perimeter 900 may have a predefined distance d from the center 310 of the radial menu 300. For example, the perimeter d may be defined by a user in the user preferences 221 illustrated in FIG. 2. While a circular perimeter is shown herein, in alternative embodiments the perimeter 900 may have any reasonable shape that encompasses the radial menu 300. The dimensions of the perimeter may be user configurable in some embodiments.

In one embodiment of the invention, a predefined second stroke as described above, if performed within a zone 910, may result in the selection of a respective radial menu item 320. If a screen pointer is moved outside the perimeter 900, all radial menu items 320 may become inactive. Therefore, if the predefined second strike is performed outside the perimeter 900, a radial menu item 320 may not be selected.

In one embodiment of the invention, selecting a radial menu item 320 may involve performing the first stroke followed by a predefined second stroke as described above. The first stroke may include moving the screen pointer in and out of the perimeter 900. An exemplary first stroke 710 is illustrated in FIG. 9. As illustrated, the first stroke 710 may begin with a movement of the mouse pointer towards a first radial menu item (“Previous Image”). As the screen pointer is moved across the pie slice representing the first radial menu item and the zone 910 associated therewith, the menu manager 115 may activate the first radial menu item. However, when the screen pointer moves outside the perimeter 900, the first radial menu item may be deactivated by the menu manager 115.

As illustrated further in FIG. 9, the first stroke may continue to move the screen pointer outside the perimeter 900 and reenter the perimeter 900 in a zone 910 associated with a second radial menu item (“Rotate Counterclockwise”). When the screen pointer enters the zone 910 associated with the second radial menu item, the menu manager 115 may activate the second menu item. However, when the screen pointer moves outside the perimeter 900 again, the second radial menu item may be deactivated by the menu manager 115.

The screen pointer may be moved in and out of the perimeter 900 several times as described above, which may result in the activation and deactivation of several radial menu items. FIG. 9, depicts the first stroke terminating in a selection zone of a third radial menu item (“Exit”), thereby activating the third radial menu item as illustrated. A predefined second stroke 720 associated with the activated menu item is also shown, which may result in the selection of the third radial menu item. In a particular embodiment, the selection may occur upon the release of a pressed mouse button.

In one embodiment of the invention, moving the screen pointer outside the perimeter 900 may result in the radial menu 300 being removed from the display screen. This may allow a user to cancel or remove the radial menu from the screen in a fluid gesture without additional actions. For example, if a user causes a radial menu to be displayed on the screen (by clicking a mouse button for example), and decides that he no longer wants to make a selection from the radial menu, the user may simply make an elongated straight line first stroke that would take the screen pointer outside the predefined perimeter 900. Upon detecting that the screen pointer is outside the perimeter 900, the menu manager 115 may remove the radial menu from the display screen.

### Displaying Radial Menus Near Screen Edges

As discussed above with reference to FIG. 5, a radial menu 300 may be displayed on a screen or in an application window on the screen upon the occurrence of a predefined screen pointer event. The radial menu 300 is generally displayed such that the center 310 of the radial menu is aligned with a location of the screen pointer 510 on the display screen. However, it is possible that the screen pointer event occurs when the screen pointer is located near an edge of the screen or an application window, which may result in at least a portion of the radial menu being hidden from view.

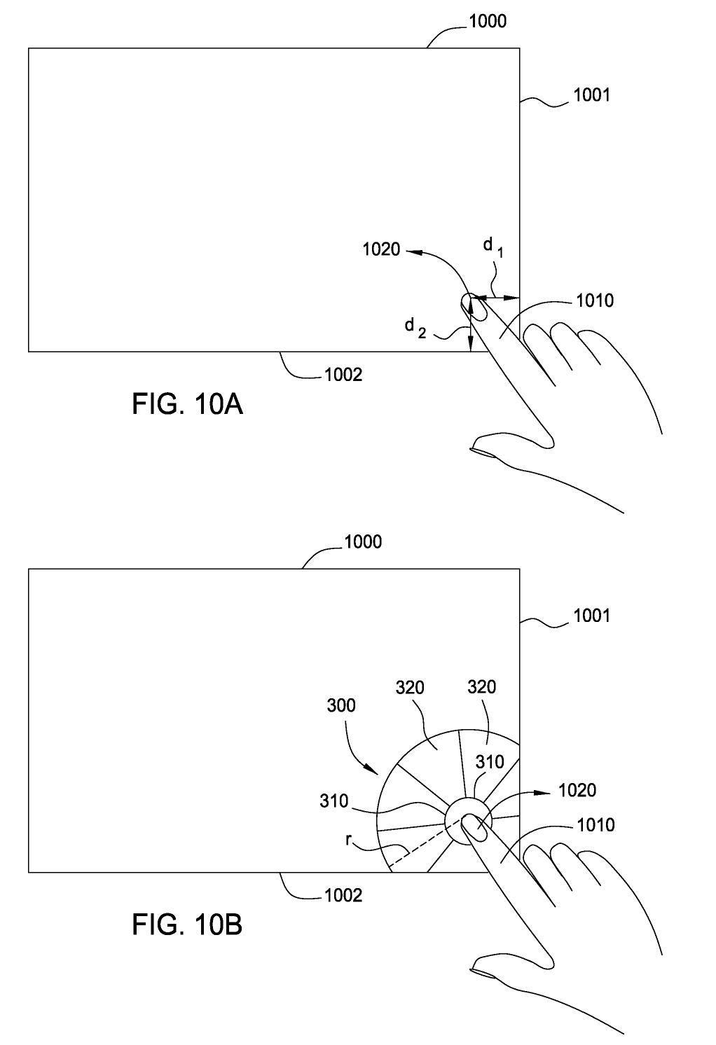

FIGS. 10A and 10B illustrates an exemplary screen event occurring near edges of a display area 1000. In one embodiment, the rectangular display area 1000 may represent the screen area of a display screen. Alternatively, the rectangular display area 1000 may define the boundaries of an application window or any other container of graphical information in which radial menus may be displayed. While a rectangular display area 1000 is disclosed herein, in alternative embodiments, the display area 1000 may have any shape, for example, a circular shape.

For illustrative purposes, a screen pointer 1010 is shown in FIGS. 10A and 10B as a human finger. As illustrated, the finger 1010 touches the display area at a location 1020 near a corner of the display area 1000. Specifically, the location 1010 is a distance d1 from a first edge 1001, and a distance d2 from a second edge 1002 of the display area 1000.

FIG. 10B, illustrates a radial menu 300 that is displayed as a result of the finger 1010 touching the display area 1000. As illustrated in FIG. 10B, the center 310 of the radial menu is aligned with the location 1020 where the finger 1010 touches the display area 1000. In the example illustrated in FIGS. 10A and 10B, the distances d1 and d2 are smaller than a radius r of the radial menu. Therefore, as illustrated in FIG. 10B, at least a portion of the radial menu may not be displayed in the display area 1000. For example, one or more of the radial menu items 320 are not visible in FIG. 10B because they fall outside the edges 1001 and 1002 of the display area 1000. It may be desirable to display all radial menu items in the display area 1000 upon the occurrence of the predefined screen pointer event so that a user is able to view all available options before making a selection in the radial menu.

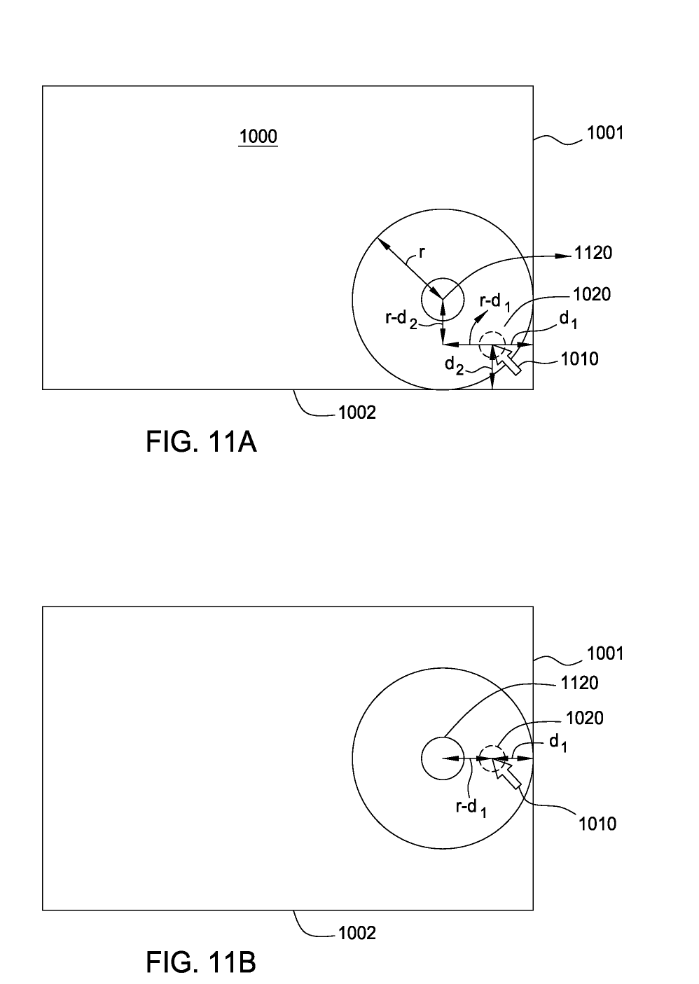

In one embodiment of the invention, if the predefined screen pointer event occurs when the screen pointer is so close to one or more edges of the display area that one or more radial menu items of the radial menu will not be visible, the menu manager 115 may be configured to displace the center 310 of the radial menu from the location of the screen pointer so that all menu items are visible in the display area 1000. For example, FIG. 11A illustrates exemplary displacement of the radial menu 300 of FIG. 10B, where the distances d1 and d2 from the screen pointer 1010 to each of the edges 1001 and 1002 are smaller than a radius r of the radial menu. As illustrated in FIG. 11A, the radial menu center 310 is displaced at least a first distance r from the first edge 1001 and at least a distance r from the second edge 1002.

As a result, the center 310 of the radial menu is displaced to a location 1120 from the location 1020 where the screen pointer 1010 is located. As illustrated in FIG. 11A, moving from location 1020 to location 1120 may involve horizontally moving the center 310 at least a distance r−d1 away from the location 1010 and vertically moving the center 310 at least a distance r−d2 away from the location 1010. As can be seen in FIG. 11A, the displacement results in all the radial menu items being displayed in the display area 1000. While the radial menu 300 is shown tangent to the screen edges 1001 and 1002 in FIG. 11A, in alternative embodiments, the radial menu 300 may be moved further into the display area 1000. This may be done, for example, to provide sufficient screen area for performing gestures for selecting radial menu items.

While displacement from two edges 1001 and 1002 are illustrated in FIG. 11A, in some cases only a single displacement from an edge of a display area may be necessary. For example, FIG. 11B illustrates a location 1020 of the screen pointer when a predefined screen pointer event for displaying a radial menu occurs. As illustrated in FIG. 11B, the screen pointer 1010 is a distance d1 from an edge 1001 of the display area 1000. The distances between the screen pointer 510 and the remaining edges of the display area may be greater than the radius r of the radial menu 300. Therefore, displacing the center 310 of the radial menu 300 from location 1020 to location 1120 may include horizontally moving the center 310 at least a distance r−d1, as illustrated in FIG. 11B.

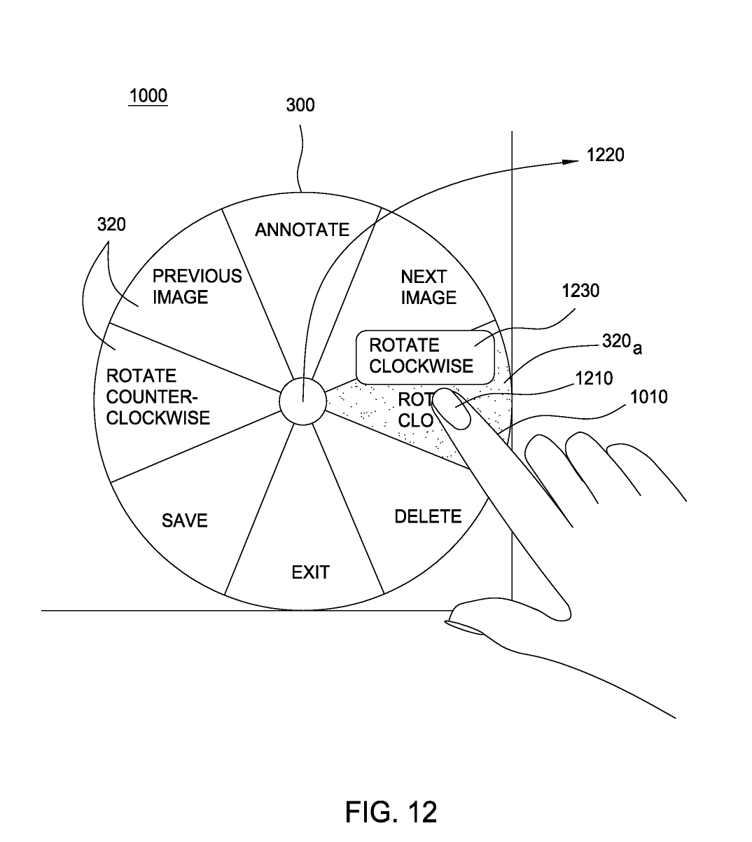

In some embodiments of the invention, the displacement of the radial menu 300, as described above, may result in the activation of one or more radial menu items. The activation may occur because, for example, the displacement may result in the screen pointer being located in a selection zone of a radial menu item. FIG. 12 illustrates exemplary activation of a radial menu item as a result of the displacement of the radial menu 300. As illustrated in FIG. 12, a screen pointer 1010 may be located at a location 1210 when a predefined screen pointer event causes a radial menu to be displayed in the display area 1000. For illustrative purposes the screen pointer 1010 is shown as a human finger. However, in alternative embodiments, screen pointer 1010 may include, for example, a mouse pointer, stylus pen, and the like.

Because the screen pointer 1010 is too close to the screen edges 1001 and 1002 in FIG. 12, the menu manager 115 may displace the center 310 of the radial menu 300 from the location 1210 (of the screen pointer 1010) to a location 1220 so that all radial menu items are shown in the display area 1000. As can be seen in FIG. 12, the screen pointer 1010 may lie over a radial menu item as a result of the displacement. Specifically, in FIG. 12, the screen pointer 1010 overlies radial menu item 320a.

In one embodiment of the invention, because the screen pointer 1010 lies over the radial menu item 320a as a result of the displacement, the menu manager 115 may activate radial menu item 320a. For example, as illustrated in FIG. 12, the radial menu item 320a, is highlighted (as indicated by the shading) to show that the menu item 320a is active. Therefore, in one embodiment, if a predefined stroke such as, for example, the predefined second stroke as described with respect to FIGS. 7A-B, is received, the radial menu item 320a may be selected. Alternatively, a first stroke may be performed to activate a radial menu item 320 other than the radial menu item 320a. Thereafter, a predefined second stroke may result in the selection of the activated radial menu item.

If displacement of a radial menu, as described above, results in a screen pointer 1010 being located above a menu item 320, it is possible that the text of the menu item will be hidden under the screen pointer. Therefore, a user viewing the radial menu may not be able to determine which radial menu item is currently active. For example, referring to FIG. 12, displacement of the radial menu 300 results in the screen pointer 1010 overlying the radial menu item 320a, which represents a “Rotate Clockwise” command/function. However, as shown in FIG. 12, the text “Rotate Clockwise” of the pie slice 320a is not entirely visible because the finger 510 covers the text.

Therefore, in one embodiment, the menu manager 115 may be configured to display a text effect on a display screen to identify a function associated with an activated radial menu item. For example, FIG. 12 illustrates an exemplary bubble text effect 1230 that is displayed when the radial menu item 320a is activated. As illustrated in FIG. 12, the bubble text effect contains the words “Rotate Clockwise”, which indicate that the active radial menu item 320a will result in a clockwise rotation of an image displayed in the display area if selected (for example, by performing a predefined stroke). In general, displaying a text effect 1230 may include any method of displaying displaced text either above, below, or any side of the location of a screen pointer such as a finger. The text effect may include any shape, with or without defined edges, in which the displaced text may be displayed.

While displaying a bubble text effect is disclosed herein, embodiments of the invention are not limited only to such text effects. More generally, any reasonable method for notifying the user of a radial menu under a screen pointer, for example, playing an audible description, providing force feedback on a mouse, controller, or other device associated with the screen pointer, and the like. In one embodiment of the invention, a text effect may be displayed in a predefined location of a display screen such as, at the bottom, top, corner or a side of the display screen. In another embodiment, the text effect may be displayed in a status area of an application window. In yet another embodiment, a secondary view of the radial menu may be displayed on the display screen, wherein the secondary view of the radial menu illustrates the activated radial menu item.

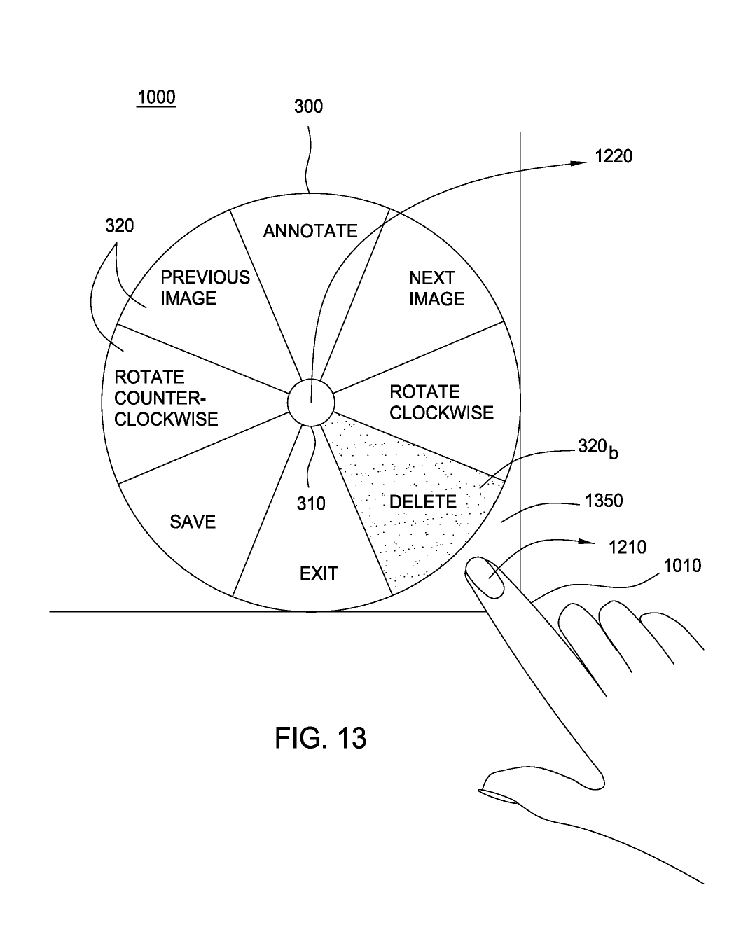

In one embodiment of the invention, displacement of the radial menu 300 by the menu manager 115 in response to detecting a screen pointer event may result in the screen pointer being outside the visible bounds of the radial menu. FIG. 13 illustrates an exemplary location 1210 of the screen pointer when a predefined screen pointer event occurs. The screen pointer event may cause the radial menu 300 to be displayed in the display area 1000 such that the center 310 of the radial menu 300 is displaced to a location 1220. As illustrated in FIG. 13, the displacement of the radial menu results in the screen pointer 1010 being located outside the bounds of the radial menu 300.

In one embodiment of the invention, if the screen pointer 1010 is outside the bounds of the radial menu 300, no radial menu item 320 may be activated. Alternatively, in some embodiments, the menu manager 115 may determine whether the screen pointer 1010 is within a predefined selection zone of a radial menu items. Predefined selection zones are described above with reference to FIGS. 8 and 9 above. Referring to FIG. 13, the screen pointer 1010 may be located in a predefined selection zone 1350 of radial menu item 320b (“Delete”). Accordingly, in one embodiment, the radial menu item 320b may be activated, as illustrated in FIG. 13.

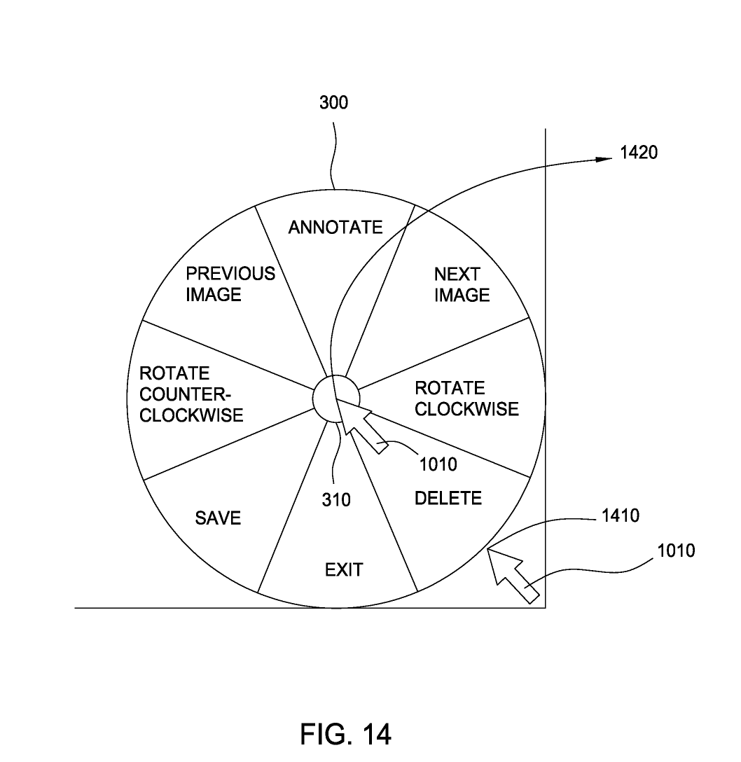

In one embodiment of the invention, the menu manager 115 may be configured to displace a screen pointer along with the radial menu. FIG. 14 illustrates an initial location 1410 of the screen pointer 1010 when a predefined screen pointer event for displaying a radial menu occurs. The screen pointer 1010 may be a mouse pointer, a trackball pointer, or the like. Because the location 1410 is too close to the edges of the screen area, the menu manager may displace the center 310 of the radial menu 300 from the location 1410 to a location 1420, as illustrated in FIG. 14.

As further illustrated in FIG. 14, the menu manager 115 may also displace the screen pointer 1010 from the location 1410 to the location 1420. By displacing the screen pointer 1010 from an initial location near the edges of a display area to a new displaced location of the center 310 of the radial menu, some embodiments of the invention may avoid a radial menu item 320 from being activated as a result of the displacement. This embodiment allows gestures in directions away from the edge.

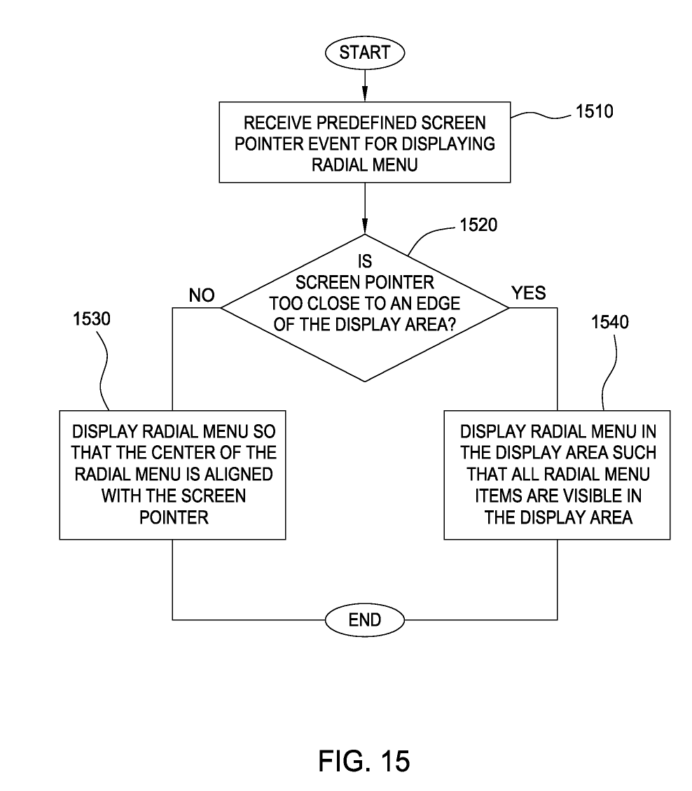

FIG. 15 is a flow diagram of exemplary operations performed by the menu manager 115 to display a radial menu in a display area, according to an embodiment of the invention. The operations may begin in step 1510 by receiving a predefined screen pointer event for displaying a radial menu in a display area. In step 1520, the menu manager may determine whether the screen pointer is too close to an edge of the display area. For example, the menu manager may compute a distance from the screen pointer to one or more screen edges. The menu manager may compare the computed distances to a radius of the radial menu to identify edges that are too close to the screen pointer.

If it is determined that the screen pointer is not too close to an edge of the display area, in step 1530, the menu manager may display the radial menu in the display area such that a center of the radial menu is aligned with the screen pointer. On the other hand, if it is determined that the screen pointer is too close to an edge of the display area, then in step 1540, the menu manager 115 may display the radial menu in the display area such that all the radial menu items are visible in the display area. For example, as discussed above, the menu manager 115 may display the radial menu such that a center 310 of the radial menu is displaced at least a distance r (radial menu radius) from the screen edge.

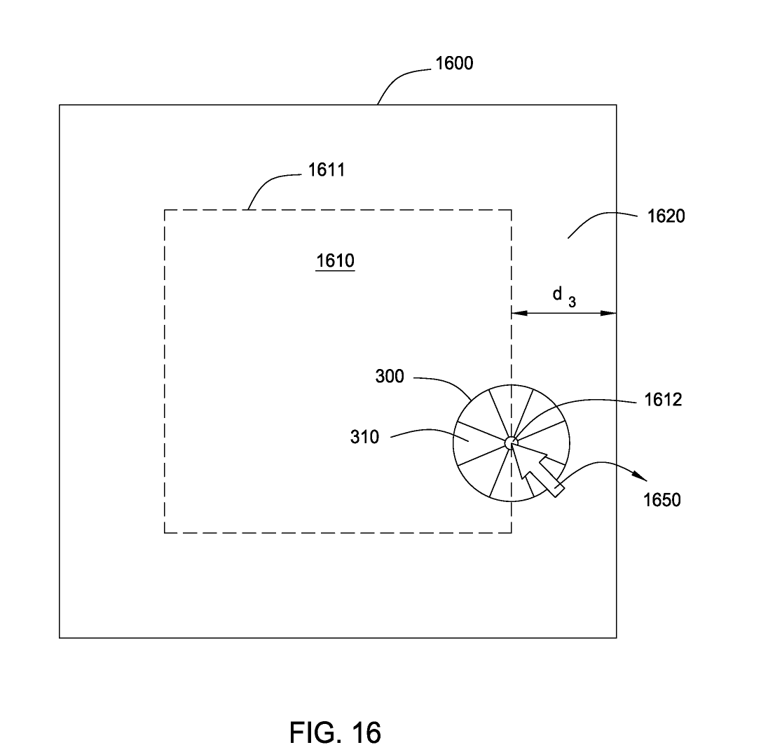

In one embodiment of the invention, radial menus may be displayed only if the screen pointer is within a predefined initialization zone of a display screen, application window, or other container of graphical information. The area of the predefined initialization zone may be less than the total area of the display screen, application window, or other container of graphical information. FIG. 16 illustrates an exemplary initialization zone 1610 within a display area 1600. The display area 1600 may represent a computer monitor screen, an application window, or the like.

As illustrated in FIG. 16, in one embodiment, the initialization zone 1610 may have a smaller area than the display area 1600. In a particular embodiment, the initialization zone 1610 may be defined by a rectangular frame 1611 within the display area 1600, as illustrated in FIG. 16. In one embodiment of the invention, the frame 1611 may be visible to a viewer of the display area 1400. For example, the sides of the frame 1611 may be shown using a solid line, dashed line, or the like. While a rectangular frame 1611 is illustrated in FIG. 14, in alternative embodiments, the frame 1611 may be any shape, for example, circular.

FIG. 16 also illustrates an idle area 1620 of the display area 1600 that is outside the bounds of the frame 1611. In one embodiment, if a predefined screen pointer event for displaying a radial menu is detected while a screen pointer 1650 is in the idle area 1620, the radial menu may not be displayed. However, if the screen pointer 1650 is in the initialization zone 1610, the radial menu may be displayed. For example, FIG. 16 illustrates a screen pointer 1650 that is within the initialization zone 1610. Therefore, upon the occurrence of a predefined screen pointer event for displaying radial menus, a radial menu 300 may be displayed as illustrated in FIG. 16.

As can be seen in FIG. 16, the radial menu 300 may be displayed such that a portion of the radial menu 300 overlaps the idle area 1620. In some embodiments the distance d3 from an edge of the frame 1611 to an edge of the display area 1600 may be at least the same as a radius r of the radial menu 300. Therefore, if the predefined screen pointer event for displaying radial menus occurs when the screen pointer is at or near the edge of the frame 1611, all radial menu items 320 will be visible within the display area 1600. Because portions of the radial menu 300 may be displayed in the idle zone 1620, in one embodiment, the menu manager 115 may be configured to recognize and respond to gestures made in the idle zone 1620 for selecting radial menu items 320. In some embodiments, although the gestures may be completed in the idle zone 1620, the gestures may be started in the initialization zone 1610.

In one embodiment of the invention, the distance d3 may be much greater than the radius r of the radial menu 300 to allow long gestures for selecting a radial menu item. For example, the distance d3 may be sufficiently large to perform elongated first strokes such as, for example, the elongated first stroke 710 described with respect to FIG. 8 above. Elongated first strokes may allow greater precision in selecting radial menu items as previously discussed. In one embodiment of the invention, the length of distance d3 may be at least as long as the distance d from the center 310 of a radial menu to a perimeter 900 defining a selection zone around the radial menu (See FIG. 9 and related description).

In one embodiment of the invention, the frame 1611 may represent the bounds of an application window and the display area 1600 may represent the area of a display screen such as, for example, a computer monitor. Accordingly, in some embodiments, one or more other graphical items such as, for example, icons, images, other application windows, etc may be displayed in the idle zone 1620 of the computer monitor. In one embodiment, the inactive zone 1620 may include translucent shading to differentiate the idle zone 1620 from the initialization zone 1610. In one embodiment, the display area 1600 may represent an application window and the frame 1611 may define an initialization zone 1610 within the application window.

In one embodiment of the invention, the menu manager 115 may be configured to display a message to the user if the predefined screen pointer event for displaying a radial menu is received when the screen pointer is in the idle zone 1620. For example, the menu manager 115 may display a pop-up window, a text bubble or the like, indicating that the screen pointer is too close to an edge of the display area to display the radial menu.

In one embodiment of the invention, a user may be allowed to modify the initialization zone 1610. For example, a user may define the shape, dimensions, etc of the initialization zone 1610 in the user preferences 221. In one embodiment, a user may be allowed to modify dimensions of the frame 1611 in the display area 1600. The frame 1611 may be resized by performing one or more gestures. For example, in one embodiment, the user may place a mouse pointer on a side of the frame 1611, press down a mouse button, drag the mouse pointer across the screen to resize the frame 1411, and release the mouse button when the frame 1611 has the desired dimensions.

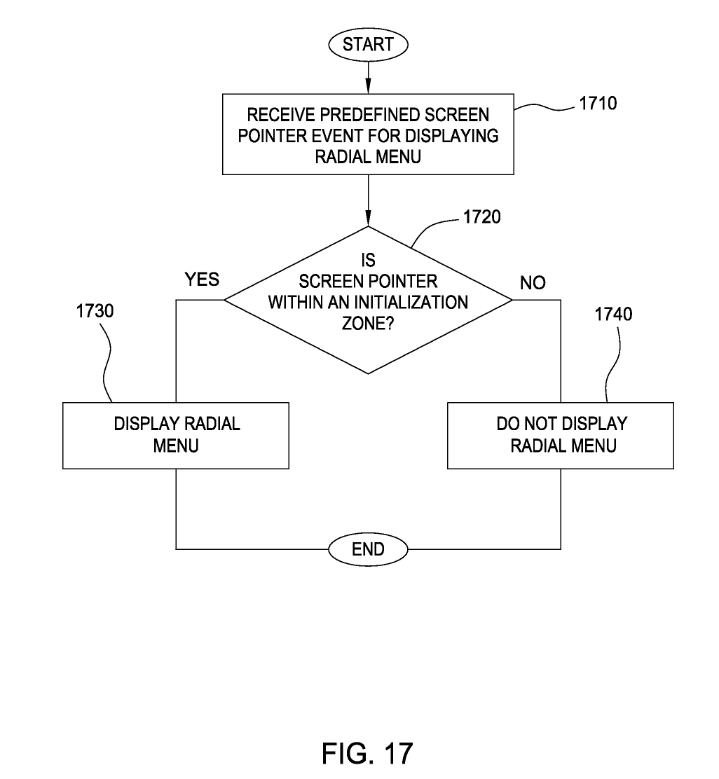

FIG. 17 is a flow diagram of exemplary operations performed by the menu manager 115 for displaying a radial menu in a display area according to an embodiment of the invention. The operations may begin in step 1710 by receiving a predefined screen pointer event for displaying a radial menu. In step 1720, the menu manager 115 may determine whether the screen pointer is within an initialization zone of the display area. For example, the menu manager may determine whether the screen pointer is within a frame 1611 when the predefined screen pointer event is received.

If it is determined that the screen pointer is within the initialization zone, in step 1730, the menu manager 115 may display the radial menu. On the other hand, if it is determined that the screen pointer is not within the initialization zone, then in step 1740, the menu manager 115 may not display the radial menu.

### Conclusion

By providing a radial menu where selections can be made with simple and quick gestures and strokes, embodiments of the invention facilitate fast selection of menu items in comparison to traditional drop down menus. Furthermore, embodiments of the invention ensure that all elements of a radial menu are displayed on a display screen regardless of the location of the screen pointer, thereby allowing users to make precise selections from the radial menu.

While the foregoing is directed to embodiments of the present invention, other and further embodiments of the invention may be devised without departing from the basic scope thereof, and the scope thereof is determined by the claims that follow.

What is claimed is:

1. A method for displaying a radial menu in a display area, comprising:
receiving a predefined screen pointer event;
in response to receiving the predefined screen pointer event, determining a first distance from a screen pointer to at least one edge of the display area;
determining whether the first distance is smaller than a radius of the radial menu; and
upon determining that the first distance is smaller than the radius of the radial menu, displaying the radial menu in the display area such that a center of the radial menu is at least a second distance from the edge, the second distance being at least as long as the radius of the radial menu.

2. The method of claim 1, further comprising placing the screen pointer over the center of the radial menu.

3. The method of claim 1, further comprising:
determining whether the screen pointer is within a predefined selection zone of a radial menu item; and
upon determining that the screen pointer is within the predefined selection zone, activating the radial menu item.

4. The method of claim 3, further comprising one of displaying a text effect identifying the activated radial menu item, playing audio describing identifying the activated radial menu item, and providing force feedback on an input device.

5. The method of claim 3, further comprising:
receiving a predefined stroke; and
in response to receiving the predefined stroke, selecting the activated radial menu item.

6. The method of claim 1, wherein the screen pointer is one of a mouse pointer, a trackball pointer, a human finger, and a stylus pen.

7. The method of claim 1, wherein the display area is a computer monitor screen.

8. The method of claim 1, wherein the display area is an application window.

9. A computer readable storage medium comprising a program product which, when executed by a processor, is configured to perform an operation for displaying a radial menu in a display area, the operation comprising:
receiving a predefined screen pointer event;
in response to receiving the predefined screen pointer event, determining a first distance from a screen pointer to at least one edge of the display area;
determining whether the first distance is smaller than a radius of the radial menu; and
upon determining that the first distance is smaller than the radius of the radial menu, displaying the radial menu in the display area such that a center of the radial menu is at least a second distance from the edge, the second distance being at least as long as the radius of the radial menu.

10. The computer readable storage medium of claim 9, wherein the operation further comprises placing the screen pointer over the center of the radial menu.

11. The computer readable storage medium of claim 9, wherein the operation further comprises:
determining whether the screen pointer is within a predefined selection zone of a radial menu item; and
upon determining that the screen pointer is within the predefined selection zone, activating the radial menu item.

12. The computer readable storage medium of claim 11, wherein the operation further comprises one of displaying a text effect identifying the activated radial menu item, playing audio describing identifying the activated radial menu item, and providing force feedback on an input device.

13. The computer readable storage medium of claim 11, wherein the operation further comprises:
receiving a predefined stroke; and
in response to receiving the predefined stroke, selecting the activated radial menu item.

14. The computer readable storage medium of claim 9, wherein the screen pointer is one of a mouse pointer, a trackball pointer, a human finger, and a stylus pen.

15. The computer readable storage medium of claim 9, wherein the display area is one of a computer monitor screen and an application window.

16. A system, comprising:
a memory comprising a program; and
a processor which, when executing the program, is configured to:
receive a predefined screen pointer event;
in response to receiving the predefined screen pointer event, determine a first distance from a screen pointer to at least one edge of a display area;
determine whether the first distance is smaller than a radius of the radial menu; and
upon determining that the first distance is smaller than the radius of the radial menu, display the radial menu in the display area such that a center of the radial menu is at least a second distance from the edge, the second distance being at least as long as the radius of the radial menu.

17. The system of claim 16, wherein the processor is further configured to place the screen pointer over the center of the radial menu.

18. The system of claim 16, wherein the processor is further configured to:
determine whether the screen pointer is within a predefined selection zone of a radial menu item; and
upon determining that the screen pointer is within the predefined selection zone, activate the radial menu item.

19. The system of claim 18, wherein the processor is further configured to display a text effect identifying the activated radial menu item.

20. The system of claim 18, wherein the processor is further configured to:
receive a predefined stroke; and
in response to receiving the predefined stroke, select the activated radial menu item.

21. The system of claim 16, wherein the screen pointer is one of a mouse pointer, a trackball pointer, a human finger, and a stylus pen.

22. The system of claim 16, wherein the display area is one of a computer monitor screen and an application window.
